(19) United States
(12) Patent Application Publication
(10) Pub. No.: US 2022/0305546 A1
(43) Pub. Date: Sep. 29, 2022

(54) SELF-PIERCING RIVETING DIE FOR MAGNESIUM ALLOY DIE CASTINGS

(71) Applicant: Magnesium Products of America Inc., Eaton Rapids, MI (US)

(72) Inventors: Yuchao Liu, London (CA); Jonathan Patrick Weiler, London (CA); Gerry Wang, London (CA)

(73) Assignee: Magnesium Products of America Inc., Eaton Rapids, MI (US)

(21) Appl. No.: 17/703,846

(22) Filed: Mar. 24, 2022

Related U.S. Application Data
(60) Provisional application No. 63/167,426, filed on Mar. 29, 2021.

(51) Int. Cl. B21J 15/36; F16B 5/04; B21J 15/02

(52) U.S. Cl. CPC B21J 15/36; F16B 5/04; B21J 15/025

(57) ABSTRACT

A self-piercing riveting (SPR) die includes a die body including an outer surface, a lower surface that is parallel to and offset from the outer surface, and a side surface that circumscribes the lower surface. A distance between the lower surface and the outer surface is less than or equal to approximately 1.2 mm. An angle between the side surface and the lower surface is within a range between approximately 45 and 90 degrees. An inner diameter of the outer surface is within a range between approximately 9 and 13 mm.

### CROSS-REFERENCE TO RELATED PATENT APPLICATIONS

This application claims the benefit of and priority to U.S. Provisional Patent Application No. 63/167,426, filed Mar. 29, 2021, the entire disclosure of which is hereby incorporated by reference herein.

### BACKGROUND

The present application relates to self-piercing riveting (SPR) technologies. More specifically, the present application relates to dies used in during the installation of self-piercing rivets.

Self-pierce riveting (SPR) is a high-speed mechanical fastening process for joining two or more sheets of material without a predrilled or punched hole. Typically, SPR processes are conducted by driving a semi-tubular rivet through top layers of material and upsetting the rivet in a lower layer (without completely piercing the lower layer) to form a durable mechanical joint. Attempts have been made to use existing SPR technologies to join magnesium alloys, which offer the potential for weight reduction over steel and aluminum alloys. However, the mechanical properties of magnesium alloys limit their use in SPR processes. For example, as a result of their reduced formability, magnesium alloys may become easily damaged during installation of the rivet into the material, and the structural integrity of the resulting magnesium alloy casting is reduced.

It would be advantageous to provide an improved method and/or system to facilitate the fastening of magnesium alloys during SPR operations that overcomes the foregoing challenges.

### SUMMARY

At least one exemplary embodiment relates to a self-piercing riveting (SPR) die. The SPR die includes a die body including an outer surface, a lower surface that is parallel to and offset from the outer surface, and a side surface that circumscribes the lower surface and extends between the lower surface and the outer surface. A distance between the lower surface and the outer surface is less than or equal to approximately 1.2 mm. An angle between the side surface and the lower surface is within a range between approximately 45 and 90 degrees. An inner diameter of the outer surface is within a range between approximately 9 and 13 mm.

Another exemplary embodiment relates to an SPR die. The SPR die includes a die body and a recessed area disposed in a first end of the die body. The recessed area includes an inner surface and a side surface that circumscribes the inner surface. The inner surface is offset from the first end by a distance that is less than or equal to approximately 1.2 mm. An angle between the inner surface and the side surface is within a range between approximately 45 degrees and 90 degrees. An outer diameter of the side surface is within a range between approximately 9 mm and 13 mm.

Yet another exemplary embodiment relates to a method of forming an SPR joint. The method includes providing a stack including an upper layer and a lower layer, where the upper layer and/or lower layer includes a magnesium layer. The method also includes engaging an outer surface of the SPR die with a surface of the stack. The SPR die includes a lower surface and a side surface circumscribing the lower surface and extending between the lower surface and the outer surface. The lower surface is spaced apart from the outer surface by a distance that is less than or equal to approximately 1.2 mm. An angle between the side surface and the lower surface is within a range between approximately 45 degrees and 90 degrees. An inner diameter of the outer surface is within a range between approximately 9 mm and 13 mm. The method further includes pressing an SPR rivet through the stack toward the SPR die.

This summary is illustrative only and should not be regarded as limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a side cross-sectional view of a conventional self-piercing riveting (SPR) joint for a magnesium alloy die casting, according to an exemplary embodiment.

FIG. 2 is bottom view of the die casting of FIG. 1.

FIG. 3A is a schematic representation of various failure modes for a magnesium alloy die casting, according to an exemplary embodiment.

FIG. 3B is an image of a side cross-sectional view of a conventional SPR joint for a magnesium alloy die casting, according to another exemplary embodiment.

FIG. 3C is an image of a bottom view of a conventional SPR joint for a magnesium alloy die casting, according to yet another exemplary embodiment.

FIG. 3D is an image of a bottom view of a conventional SPR joint for a magnesium alloy die casting, according to yet another exemplary embodiment.

FIG. 4 is a perspective view of an SPR die, according to an exemplary embodiment.

FIG. 5 is a top view of the SPR die of FIG. 4.

FIG. 6 is a side cross-sectional view of the SPR die of FIG. 4.

FIG. 7 is a side cross-sectional view of a cavity portion of the SPR die of FIG. 4.

FIG. 8 is a flow diagram of a method of forming an SPR joint, according to an exemplary embodiment.

FIGS. 9-10 are side cross-sectional views of SPR joints formed using the SPR die of FIG. 5, according to various exemplary embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The present disclosure relates to self-piercing riveting (SPR) technologies and forming tools for self-piercing rivets. SPR is a technique used to join sheets of materials into a single material casting. These die castings are particularly useful in automotive applications (e.g., shock towers, body panels, etc.) where weight savings can increase the overall performance of the vehicle. Unlike conventional riveting operations, which require hole and/or openings to guide the rivets through the sheets before fastening the materials together, the rivets used in SPR joints require no predrilling or machining of the receiving materials. Rather, the rivets are pressed through unformed sheets and deform and/or pierce the sheets to create a robust mechanical interlock. To install the SPR rivet, the sheets of material are layered on top of one another in a desired orientation. The stack of materials is then clamped between a die and a blankholder (e.g., fixture, etc.) that holds the stack against the die. Next, a press drives the rivet, from an upper side of the stack, into the stack and toward the die, piercing the upper sheet and causing the lower sheet to expand into the die. The shape of the die causes the rivet and the lower sheet to flair outwards, forming a button-shaped protrusion in the lower sheet and a robust mechanical connection to hold the sheets together. SPR joining techniques work particularly well for connecting sheets made from steel and aluminum alloys (e.g., metals having a face-centered cubic metal crystalline structure), which have high ductility to reduce the likelihood of cracking during rivet installation.

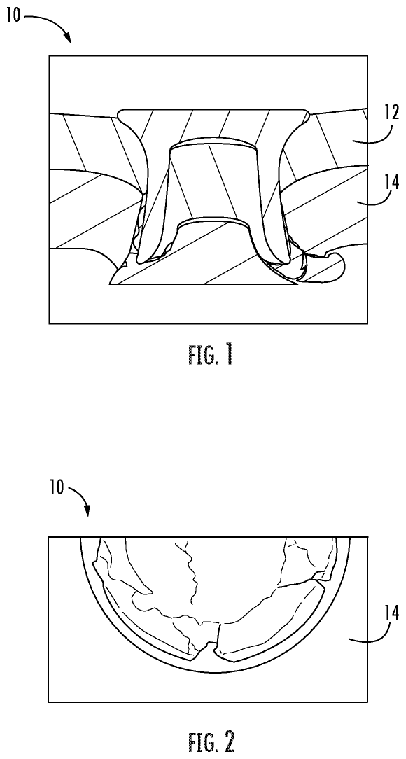

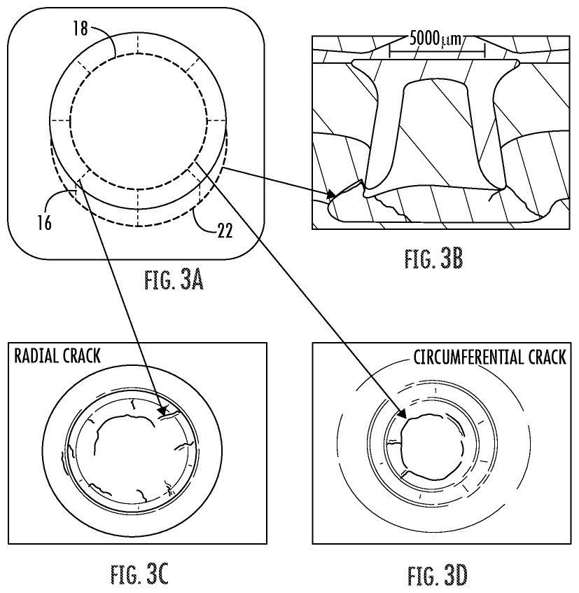

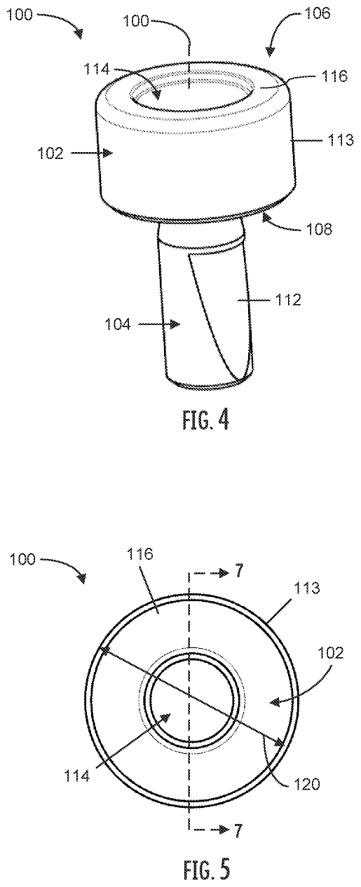

Magnesium alloys provide a strong and lightweight alternative to traditional SPR materials. However, compared to their aluminum and steel counterparts, the hexagonal closed pack crystalline structure of magnesium alloys reduces the maximum allowable deformation of the material before cracking occurs. By way of example, FIGS. 1-2 show side cross-sectional and bottom views of an SPR joint 10 for a magnesium alloy die casting. The SPR joint 10 is formed from two metal sheets including an upper sheet 12 (e.g., layer, etc.) formed from a 5000 series aluminum alloy, and a bottom sheet 14 formed from an AM60 magnesium alloy. Among other benefits, the aluminum alloy separates the surfaces of the steel rivet from the magnesium alloy to reduce the likelihood of galvanic corrosion. As shown, the force of the rivet pressing against the magnesium alloy layer results in severe cracking (e.g., button cracking) radiating from the tail of the rivet along the perimeter of the button-shaped area, which reduces the structural integrity of the die casting. FIGS. 3-4 show additional failure modes that may result from the joining of magnesium alloy sheets using SPR. Failure modes include (i) edge cracks 22 that emanate from the tip of the rivet beyond an outer perimeter of the button and extend circumferentially about the button (see FIG. 3B); (ii) radial cracks 16 along the outer portion of the button-shaped area that extend radially across a surface transition at the outer portion (see FIG. 3C); (iii) circumferential cracks 18 that extend circumferentially along a lower face of the button (see FIG. 3D); and (iv) bumps where a section of the magnesium shears outwardly from the lower face of the button, among other failure modes (e.g., shear cracking, etc.).

Referring to the figures generally, a forming die is shown that enables joining of magnesium alloys using SPR techniques and that significantly reduces the risk of cracking at the SPR joint. The forming die includes a recessed area (e.g., cavity, depression, etc.) that is uniquely shaped to control the volume of deformed magnesium alloy during rivet installation, to reduce overall deformation, and to reduce transitions (e.g., sharp edges, corners, etc.) at the outer edge of the button. Among other benefits, the forming die has proved capable of joining a wide range of materials and material thicknesses without cracking the magnesium alloy sheet.

FIG. 4-7 show a forming die 100 for an SPR joining tool, according to an exemplary embodiment. The joining tool may be a mechanical press, a self-piercing rivet gun, or another sheet material joining apparatus. As shown in FIG. 4, the die 100 includes a die body 102 and a shank 104 (e.g., stem, coupler, etc.) that is configured to engage with the SPR joining tool and to secure the die body 102 to the tool. The die body 102 includes a first (e.g., upper) end 106 and a second (e.g., lower) end 108 spaced axially apart from the first end 106. The shank 104 is coupled to the second end 108 and extends axially away from the second end 108. In at least one embodiment, the shank 104 and the die body 102 are integrally formed as a single unitary structure/body (e.g., are cast or otherwise formed from a single piece of material, are inseparable without damaging the die 100, etc.). The die 100 may be formed from a hardened steel or another suitable material to resist deformation under loading during SPR operations.

In at least one exemplary embodiment, the shank 104 is a cylindrically-shaped extension (e.g., rod, post, etc.) that extends parallel to a central axis 110 of the die body 102, such that the shank 104 is concentric with the die body 102. The shank 104 may include at least one slot, notch, cut, groove, channel, or the like to facilitate engagement with the joining tool or coupling between the shank 104 and the joining tool. As shown in FIG. 4, the shank 104 includes an angled notch 112 that extends axially along the shank 104, from a lower end of the shank 104 to an intermediate position between opposing axial ends of the shank 104. The shank 104 is also tapered radially inward between the notch 112 and the die body 102, such that an outer diameter of the shank 104 is reduced where the shank 104 connects with (e.g., engages) the die body 102. It will be appreciated that the design of the shank 104 may be different in various exemplary embodiments to accommodate different types of SPR joining equipment.

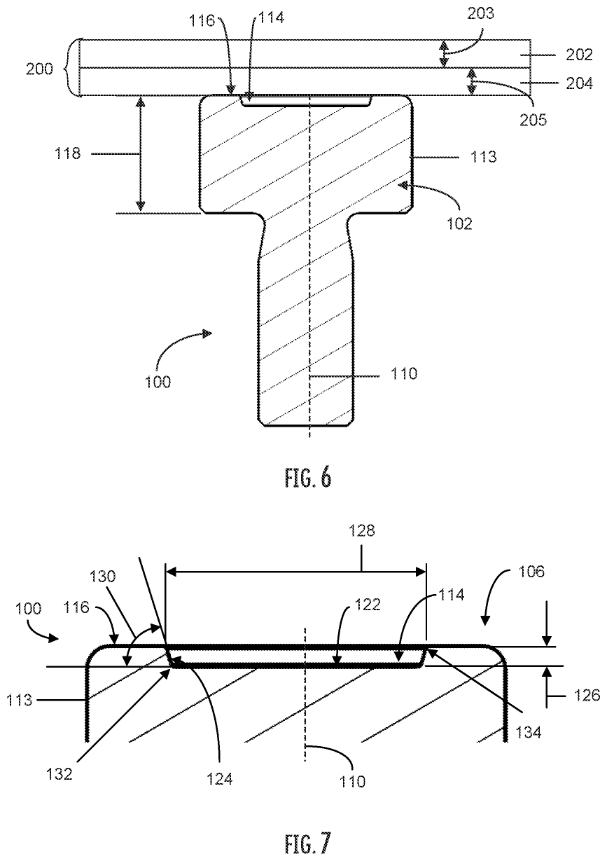

As shown in FIG. 6, the die body 102 is configured to engage with a lower surface of a stack 200 of metal sheets and to provide a supporting surface for the stack 200 to accommodate deformation of at least a portion of the stack 200 during rivet installation. In the embodiment of FIG. 6, the stack 200 includes an upper (e.g., top) layer 202 and a lower (e.g., bottom) layer 204 that is disposed between the upper layer 202 and the die body 102. The lower layer 204 may be in direct contact with the upper layer 202 or may be at least partially separated from the upper layer 202 by an intervening adhesive layer.

In at least one embodiment, the upper layer 202 (e.g., sheet, etc.) includes at least one steel material layer and/or one aluminum material layer. The steel layer(s) may have a variety of different compositions. For example, in one embodiment, the steel may be a low carbon steel (e.g., mild steel) having iron alloyed with about 0.25 wt % carbon. In another embodiment, the steel may be a high carbon steel having iron alloyed with up to about 2.5 wt % carbon. In other embodiments, the steel may be a stainless steel having iron alloyed with chromium and nickel. According to other embodiments, steel may be used comprising at least one of iron, carbon, manganese, chromium, nickel, tungsten, molybdenum, boron, titanium, vanadium, cobalt, niobium, or a combination thereof. For example, the steel layer may comprise CR3 steel, which includes about 0.10% carbon (C), about 0.45% manganese (Mn), at most 0.03% sulfur (S), at most 0.04% phosphorus (P), balance iron (Fe), and trace impurities, a CR2 steel, a ferrite-martensite dual phase (DP) 600 steel, which includes about 0.10% carbon (C), about 1.4% manganese (Mn), about 0.14% silicon (Si), balance iron (Fe), and trace impurities, galfan (GF) steel and/or cold formed (CF) steel composite, advanced high strength (AHSS) steel, and/or another steel or steel alloy.

The aluminum layer(s) may include an aluminum casting, an aluminum extrusion, an aluminum sheet, or the like. In one embodiment, at least one layer of aluminum may be a 1000 series aluminum alloy, a 2000 series aluminum alloy, a 3000 series aluminum alloy, a 4000 series aluminum alloy, a 5000 series aluminum alloy, a 6000 series aluminum alloy, a 7000 series aluminum alloy, or an 8000 series aluminum alloy.

The 1000 series aluminum alloy (i.e. 1050, 1060, 1070, 1100, 1145, 1199, 1350, etc.) is essentially pure aluminum with a minimum 99 wt % aluminum content and may be work hardened. The 2000 series aluminum alloy (i.e. 2011, 2014, 2024, 2036, 2048, 2090, 2091, 2099, 2124, 2195, 2218, 2219, 2319, 2618, etc.) is alloyed with copper and may be precipitation hardened to strengths comparable to steel. The 3000 series aluminum alloy (i.e. 3003, 3004, 3005, 3102, 3103, 3105, 3303, etc.) is alloyed with manganese and may be work hardened. The 4000 series aluminum alloy (i.e. 4006, 4007, 4015, 4032, 4043, etc.) is alloyed with silicon. The 5000 series aluminum alloy (i.e. 5005, 5010, 5019, 5026, 5050, 5052, 5056, 5059, 5083, 5086, 5154, 5182, 5252, 5254, 5356, 5454, 5456, 5457, 5652, 5657, 5754, Al3Mg, etc.) is alloyed with magnesium and offer enhanced corrosion resistance. The 6000 series aluminum alloy (i.e. 6005, 6009, 6010, 6060, 6061, 6063, 6063A, 6065, 6066, 6070, 6081, 6082, 6101, 6105, 6151, 6162, 6201, 6205, 6262, 6351, 6463, etc.) is alloyed with magnesium and silicon and is machinable, weldable, and may be precipitation hardened. The 7000 series aluminum alloy (i.e. 7005, 7039, 7049, 7050, 7068, 7072, 7075, 7079, 7116, 7129, 7175, 7178, 7475, etc.) is alloyed with zinc and may be precipitation hardened to the highest strengths of any aluminum alloy, with a tensile strength up to 700 MPa. The 8000 series aluminum alloy (i.e. 8011, 8090, etc.) is alloyed with elements which are not covered by 1000-7000 series aluminum alloys.

In at least one embodiment, the upper layer 202 includes a magnesium casting, magnesium extrusion, magnesium sheet, or another magnesium material layer.

In at least one embodiment, the lower layer 204 includes a magnesium layer, such as a magnesium alloy. The magnesium alloy may be, for example, AE42, AE44, AM20, AM40, AM50, AM60, AM60B, AS21, AS41, AZ31, AZ61, AZ63, AZ80, AZ81, AZ91, Elektron 21, Elektron 675, EZ33, HK31, HM21, HZ32, K1A, LA141, LA103, LAZ43, M1, M1A, QE22, QH21, WE43, WE54, ZC63, ZC71, ZE41, ZK10, ZK20, ZK30, ZK40, ZK51, ZK60, ZK61, ZM21, ZMC711, any alloys with magnesium contents of 80% of higher, or a combination thereof. In at least one exemplary embodiment, the magnesium layer may include AM60B magnesium alloy, which includes about 5.5-6.5% aluminum (Al), about 0.24-0.6% manganese (Mn), at most about 0.22% zinc (Zn), at most about 0.1% silicon (Si), at most about 0.01% copper (Cu), at most about 0.005% iron (Fe), at most about 0.002% nickel (Ni), balance magnesium (Mg), and trace impurities. The lower layer 204 may be a magnesium casting, a magnesium extrusion, a magnesium sheet, or the like. In at least one exemplary embodiment, the magnesium layer may include a coating material. For example, the magnesium layer may be pre-coated using an electrophoretic coating, or may include a powder coat on a lower surface that faces the die body 102.

The thickness of each material layer may vary depending on the desired properties of the stack 200. Among other benefits, the same die body 102 design may be used to accommodate a wide variety of material layer thicknesses without causing cracking of the magnesium die casting. As shown in FIG. 6, a thickness 203 of the upper layer 202 is less than or equal to approximately 2.5 mm. For example, the upper layer may be a 1.3 mm CR2 steel sheet, a 0.8 mm CR3 steel sheet, a 1.0 mm DP600 steel sheet, a 2.0 mm 6061-T6 aluminum sheet, a 2.5 mm 6061-T6 aluminum sheet, or another material/thickness combination. In at least one embodiment, a thickness 205 of the lower layer 204 is within a range between approximately 2 and 4 mm. For example, the lower layer 204 may be a 3.2 mm AM50 magnesium alloy sheet, etc. The foregoing material specifications, in combination with the geometry of the die body 102, have been shown to significantly reduce the risk of cracking in the SPR joint. However, it will be appreciated that other material thicknesses and combinations may be used while still increasing the structural integrity of the SPR joint relative to conventional forming die designs.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The rivet may be one of a variety of SPR rivets made from steel or another suitable material. For example, the rivet may be a tubular rivet made from high strength steel.

The die body 102 is uniquely shaped to limit the deformation of the magnesium layer (e.g., lower layer 204) while allowing the rivet to achieve proper volume displacement during the joining operation to ensure a robust mechanical interlock between the sheets in the stack 200. As shown in FIGS. 4-7, the die body 102 is a substantially cylindrical body having a cylindrical outer wall 113. In other embodiments, the shape of the die body 102 may be different. As shown in FIGS. 4-7, the die body 102 includes a recessed area 114 (e.g., cavity, depression, etc.) disposed in an outer surface 116 (e.g., axially facing surface, etc.) on the first end 106 of the die body 102. As shown FIGS. 6-7, the recessed area 114 is disposed in a central position along the outer surface 116 and is approximately coaxial with the cylindrical outer wall 113. In the embodiment of FIGS. 4-7, an axial length 118 of the die body 102, between the first end 106 and the second end 108 is approximately 10 mm (see FIG. 6) (e.g., greater than or equal to 10 mm). An outer diameter 120 of the die body 102 is approximately 18 mm (see FIG. 5) (e.g., greater than or equal to 18 mm, etc.). It will be appreciated that the size and shape of the die body 102 may differ in various exemplary embodiments.

As shown in FIG. 7, the first end 106 of the die body 102 is defined by the outer surface 116 and the recessed area 114. The outer surface 116 is a substantially planar surface that is oriented substantially perpendicular to the central axis 110 of the die body 102. The recessed area 114 is defined by a combination of a lower surface 122 (e.g., an inner surface, etc.) and a side surface 124. The lower surface 122 is offset from and oriented parallel to the outer surface 116. The lower surface 122 is also a substantially planar surface. In some embodiments, the depth of the lower surface 122 (e.g., the axial distance between the outer surface 116 and the lower surface 122) is a function of the total thickness of the stack 200 and the height of the rivet (see also FIG. 6). For example, an increase in the total thickness of the stack 200 may require a deeper recessed area 114 to reduce the likelihood of cracking at the button formed by the SPR joint. In at least one embodiment, an axial distance 126 between the outer surface 116 and the lower surface 122 (e.g., between the first end 106 of the die body 102 and the inner surface, etc.) is less than or equal to approximately 1.2 mm (e.g., within a range between 0.7 mm and 1.0 mm, etc.). In at least one embodiment, an inner diameter 128 of the outer surface 116 (e.g., an outer diameter of the side surface 124 and/or at a transition between the outer surface 116 and the side surface 124) is within a range between approximately 9 mm and 13 mm (e.g., within a range between 9 mm and 12 mm, etc.).

As shown in FIG. 7, the side surface 124 circumscribes the lower surface 122 and extends in an at least partially radial direction between the lower surface 122 and the outer surface 116. In the embodiment of FIG. 7, the side surface 124 extends at an oblique (e.g., non-perpendicular) angle relative to the lower surface 122 and the outer surface 116, such that the side surface 124 forms a cone shape (e.g., a frustoconical shape). In at least one embodiment, the angle 130 between the side surface 124 and the lower surface 122 is within a range between approximately 45 and 90 degrees (e.g., within a range between approximately 70 degrees and 80 degrees, within a range between approximately 73 degree and 77 degrees, approximately 75 degrees, etc.). In at least one embodiment, a radius 132 at the transition between the lower surface 122 and the side surface 124 is approximately 0.2 mm. A radius 134 at the transition between the side surface 124 and the outer surface 116 may be approximately the same as the radius 132 between the lower surface 122 and the side surface 124. In other embodiments, the radius 134 at the transition between the side surface 124 and the outer surface 116 may be different.

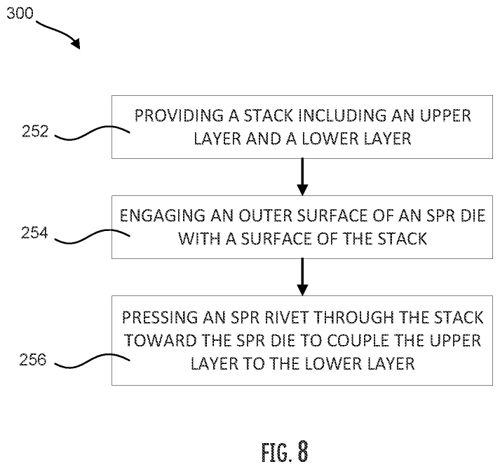

FIG. 8 shows a method 250 of forming an SPR joint and/or magnesium die casting using the SPR die of FIGS. 4-7. The method 250 may be performed using the SPR die 100 of FIGS. 4-7. As such, the method 250 will be described with reference to FIGS. 4-7. In other embodiments, the method 250 may include additional, fewer, and/or different operations.

At 252, an upper layer (e.g., the upper layer 202 of FIG. 6) and a lower layer (e.g., the lower layer 204 of FIG. 6) are provided, where at least one of the upper layer and the lower layer includes and/or is made from a magnesium layer. Operation 252 may include stacking the upper layer and the lower layer together by placing the upper layer above (e.g., on an upper surface of, etc.) the lower layer. In one embodiment, operation 252 includes pre-coating the magnesium layer using an electrophoretic coating and/or applying a powder coat on a lower surface (e.g., a bottom surface) of the magnesium layer that faces the SPR die. In some embodiments, operation 252 includes placing the upper layer in direct contact with the lower layer. In other embodiments, operation 252 includes applying an adhesive layer between the upper layer and the lower layer.

At 254, the SPR die is brought into engagement with the stack that includes the upper layer and the lower layer. Operation 254 may include engaging an outer surface of the SPR die with a lower surface of the lower layer, manually or by activating an SPR joining tool to draw the SPR die up against the lower surface of the lower layer. The SPR die may be the same as or similar to the SPR die described with reference to FIGS. 4-7. Operation 254 may include clamping the stack between the SPR die and a blankholder that holds the stack against the SPR die.

At 256, an SPR rivet is provided and pressed through the stack into the SPR die to couple the upper sheet and the lower sheet together (with the SPR rivet). Operation 256 may include providing a tubular rivet made from steel (e.g., inserting the SPR rivet into a joining tool that includes the SPR die) and applying a force to the SPR rivet and/or die to deform and/or pierce the sheets in the stack. Operation 256 may include using a press to drive the rivet from an upper side of the stack, into the stack and toward the die, piercing the upper sheet and causing the lower sheet to expand into the SPR die to form a button-shaped protrusion in the lower sheet.

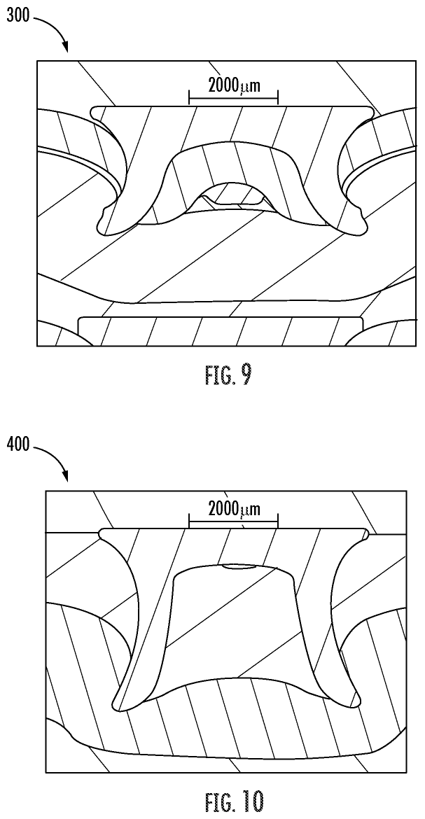

The forming die design of the present disclosure provides several benefits over traditional SPR dies. The forming die includes a recessed area that is uniquely shaped to control the volume of the deformed magnesium alloy, to reduce deformation of the magnesium alloy during rivet installation, and to reduce transitions (e.g., sharp edges, corners, etc.) along the outer edge of the recessed area. This unique shape reduces the likelihood of cracking during rivet installation into the magnesium alloy. For example, FIGS. 9-10 show cross-sectional views of two different magnesium die castings, shown as die casting 300 and die casting 400, respectively. As shown, the unique geometry of the forming die ensures uniform and controlled deformation of the magnesium layer, without any observable cracks or structural defects.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The construction and arrangement of the elements of the SPR joint as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements, the position of elements may be reversed or otherwise varied, and the nature or number of discrete elements or positions may be altered or varied.

Although the figures and description may illustrate a specific order of method steps, the order of such steps may differ from what is depicted and described, unless specified differently above. Also, two or more steps may be performed concurrently or with partial concurrence, unless specified differently above.

Other substitutions, modifications, changes and omissions may also be made in the design, operating conditions and arrangement of the various exemplary embodiments without departing from the scope of the present invention. For example, any element disclosed in one embodiment may be incorporated or utilized with any other embodiment disclosed herein. Also, for example, the order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes and omissions may be made in the design, operating configuration, and arrangement of the preferred and other exemplary embodiments without departing from the scope of the appended claims.

What is claimed is:

1. A self-piercing riveting (SPR) die, comprising:
a die body, comprising:
an outer surface;
a lower surface that is parallel to and offset from the outer surface, wherein a distance between the lower surface and the outer surface is less than or equal to approximately 1.2 mm; and
a side surface circumscribing the lower surface and extending between the lower surface and the outer surface, wherein an angle between the side surface and the lower surface is within a range between approximately 45 degrees and 90 degrees, and wherein an inner diameter of the outer surface is within a range between approximately 9 mm and 13 mm.

2. The SPR die of claim 1, wherein the outer surface, the lower surface, and the side surface are disposed at a first end of the die body, and wherein the outer surface is concentric with the lower surface.

3. The SPR die of claim 1, further comprising a shank coupled to a second end of the die body opposite the outer surface, and extending axially away from the second end.

4. The SPR die of claim 3, wherein the shank is concentric with the die body and includes an angled notch that extends axially along the shank.

5. The SPR die of claim 3, wherein the shank is tapered radially inward so that an outer diameter of the shank is reduced where the shank engages the die body.

6. The SPR die of claim 1, wherein the distance between the outer surface and the lower surface is within a range between approximately 0.7 mm and 1.0 mm.

7. The SPR die of claim 1, wherein the inner diameter of the outer surface is within a range between approximately 9 mm and 12 mm.

8. The SPR die of claim 1, wherein the angle between the side surface and the lower surface is within a range between approximately 73 degrees and 77 degrees relative to the lower surface.

9. The SPR die of claim 1, wherein the angle between the side surface and the lower surface is approximately 75 degrees.

10. The SPR die of claim 1, wherein a radius at a transition between the lower surface and the side surface is approximately 0.2 mm.

11. An SPR die, comprising:
a die body; and
a recessed area disposed in a first end of the die body, the recessed area comprising an inner surface and a side surface that circumscribes the inner surface, the inner surface offset from the first end by a distance that is less than or equal to approximately 1.2 mm, wherein an angle between the inner surface and the side surface is within a range between approximately 45 degrees and 90 degrees, and wherein an outer diameter of the side surface is within a range between approximately 9 mm and 13 mm.

12. The SPR die of claim 11, further comprising a shank coupled to a second end of the die body opposite the first end, and extending axially away from the second end.

13. The SPR die of claim 11, wherein the distance between the first end and the inner surface is within a range between approximately 0.7 mm and 1.0 mm.

14. The SPR die of claim 11, wherein the outer diameter of the side surface is within a range between approximately 9 mm and 12 mm.

15. The SPR die of claim 11, wherein the angle between the side surface and the inner surface is within a range between approximately 73 degrees and 77 degrees relative to the inner surface.

16. The SPR die of claim 11, wherein the angle between the side surface and the inner surface is approximately 75 degrees.

17. A method of forming an SPR joint, comprising:
providing a stack including an upper layer and a lower layer, at least one of the upper layer or the lower layer including a magnesium layer;
engaging an outer surface of an SPR die with a surface of the stack, the SPR die comprising:
a lower surface that is spaced apart from the outer surface by a distance that is less than or equal to approximately 1.2 mm; and
a side surface circumscribing the lower surface and extending between the lower surface and the outer surface, wherein an angle between the side surface and the lower surface is within a range between approximately 45 degrees and 90 degrees, and wherein an inner diameter of the outer surface is within a range between approximately 9 mm and 13 mm; and
pressing an SPR rivet through the stack toward the SPR die.

18. The method of claim 17, wherein providing the stack comprises providing one of a steel material layer, an aluminum material layer, or a first magnesium layer as the upper layer and providing a second magnesium layer as the lower layer, and wherein engaging the outer surface of the SPR die with the stack comprises engaging the outer surface with the lower layer.

19. The method of claim 18, wherein providing the second magnesium layer comprises at least one of pre-coating the second magnesium layer using an electrophoretic coating or powder coating a bottom surface of the second magnesium layer that faces the SPR die.

20. The method of claim 18, wherein a thickness of the upper layer is less than or equal to approximately 2.5 mm, wherein a thickness of the lower layer is within a range between approximately 2 and 4 mm.
